(19) United States
(12) Patent Application Publication
(10) Pub. No.: US 2012/0331126 A1
(43) Pub. Date: Dec. 27, 2012

(54) DISTRIBUTED COLLECTION AND INTELLIGENT MANAGEMENT OF COMMUNICATION AND TRANSACTION DATA FOR ANALYSIS AND VISUALIZATION

(75) Inventors: MOHAMMED ABDUL-RAZZAK, Union City, CA (US); Subhrajyoti Ray, San Jose, CA (US)

(73) Assignee: SS8 Networks, Inc., Milpitas, CA (US)

(21) Appl. No.: 13/167,632

(22) Filed: Jun. 24, 2011

(51) Int. Cl. G06F 15/173

(52) U.S. Cl. 709/224

(57) ABSTRACT

Systems and methods of collecting, storing and transmitting a set of communication and transaction data across a distributed system spanning multiple networks are disclosed. In one embodiment, the method may include distributing a set of collection servers throughout a distributed network to collect a set of communication and transaction data. The method may also include processing the set of communication and transaction data to extract metadata and a content. The method may include storing the content in the collection server. The method may also include automatically transmitting the metadata to a service platform to be used by an analyst at a workstation. The method may also include transmitting the content to the service platform to be used by the analyst, for analysis and reconstruction purposes when specifically requested by the analyst.

### FIELD OF TECHNOLOGY

This disclosure relates to a collection, storage, transportation, and organization of a set of communication and transaction data collected from a network being used by a person of interest.

### BACKGROUND

An analyst (e.g., a law enforcement analyst, a financial analyst, an analyst managing finance/stocks/mutual-funds, an analyst at an IT department, a marketing analyst, a local police officer, a secret agent, a member of an intelligence agency etc.) may want to collect a set of data stored in a data processing unit associated with a person of interest. The person of interest (POI) may be any individual under investigation for any reason. The analyst may want to tap into set of communications between the person of interest and correspondents to the person of interest to find more leads on the investigation. For example, the analyst may want to access an email account associated with the person of interest. The analyst may want to tap into a network used by the person of interest and extract the email record and any other cyber-data available on a data processing unit associated with the person of interest. The analyst may want to access a set of information quickly. The analyst may want to collect and organize a set of communication and transaction data to perform a set of analysis and visualization functions on the set of communication and transaction data. The set of communication and transaction data may be collected at a location that may be far away from a location of the analyst. The analyst may want the information from the location of collection to be transmitted to him/her quickly, but the data set intercepted may be too large and may be too time consuming to effectively communicate to the analyst. As a result, the analyst may lose valuable time in finding links and/or relationships between the sets of communication and transaction data and may fail to find crucial links and/or suspects in the investigation. The analyst may also waste time looking at information that may not be useful in the investigation, and the investigation may get unnecessarily delayed and wasteful. Finally, the delayed investigation may mean that the person of interest may remain a public threat for a longer period of time, thereby endangering lives and property.

### SUMMARY

This disclosure relates to a collection, storage, transportation, and organization of a set of communication and transaction data extracted from a network being used by a person of interest.

The methods and the systems disclosed herein may be implemented in any means for achieving various aspects. Other features will be apparent from the accompanying drawings and from the detailed description that follows.

In one aspect, the method may include distributing a set of collection servers throughout a distributed network to collect a set of communication and transaction data. The method may also include extracting the set of communication and transaction data, through a collection interface module and a data processing unit at the collection server. The method further includes processing the set of communication and transaction data, through the data processing engine, to generate a metadata and a content. The method also includes storing the content in a storage module in the collection server. The method also includes transmitting at least one of the metadata and a text content in a communication bus to a service platform.

The method may also include transmitting the content through the communication bus at a request of an analyst for visualization and analysis. The method further includes reducing a traffic on the network by transmitting the content only at the request of the analyst.

The method further includes collecting the set of communication and transaction data through a network element. The network element may be a network filtering device, a mediation function and a data repository.

The method may further include organizing the set of communication and transaction data at the service platform. The method further includes analyzing the set of communication and transaction data through an analysis module at the service platform. The method also includes reconstructing the set of communication and transaction data though a reconstruction module at the service platform.

The metadata may be at least one of an information about an IP packet, an information about a type of data collected, an IP information, a cyber-address, an event information, a geographical information about an event, a source and destination IP address of a cyber-activity, a version, a length, a set of cyber options, a padding information , error correction information, identification of a sender of an email, identification of a receiver of a cyber-communication, an email flag, a protocol information, a subject line of a cyber-communication, an attachment information, a routing information and a proxy server information, a telephony record, a social networking data and address of a website, a device identification information, a mac address, an International Mobile Equipment Identity(IMEI) of a cell phone.

The content may be at least one of a content of an email, an attachment, a content of a website, a content of an electronic chat, a content of a web address, a content of an article, a set of files transmitted across the network, a set of images, a set of audio files, a set of video files, a chat transcript, an email transcript, a telephone transcript, a substantive content of an electronic transmission, a substantive content of an electronic conversation, a set of data associated with a cyber-address, a set of data associated with a physical address, a set of data associated with the geographical location, a set of data associated with a web host, a set of data associated with a warrant.

The method further includes storing at least one of the metadata and the text content in a database in the service platform. The method also includes creating an index at the service platform to enable a fast search of the database. The method also includes enabling an analyst at a workstation associated with the service platform to access the metadata at the service platform irrespective of a connectivity of the network to the storage module at the collection server

The method further includes enabling the collection server to connect to any network used by the person of interest to collect the set of communication and transaction data, irrespective of a format of the set of communication and transaction data.

The method further includes developing an interface with a third party to provide an access to the database in the service platform. The method also includes coupling the service platform with an analysis module associated with the third party to integrate a set of analytical services provided by the third party.

In another aspect, a system comprising a processor communicatively coupled with a volatile memory and a non-volatile storage may include a collection server to collect a set of communication and transaction data from a network, to process the set of communication and transaction data to extract a metadata and a content of the set of communication and transaction data and to store the content. The system also includes a service platform to receive and store the metadata and the text content and to present the set of communication and transaction data to an analyst. The system also includes a communication bus to automatically transmit the metadata and a text content to the service platform from the collection server immediately at a time to collection of the set of communication and transaction data and to store the content locally at the collection server and to transmit the content to the service platform at a request of the analyst.

The system further includes a database in the service platform to store the metadata and the text content.

The system also includes a storage module in the collection server to store the content. The system also includes a collection interface module in the collection server to collect the set of communication and transaction data. The system also includes a data processing engine in the collection server to process the set of communication and transaction data and to generate the metadata and the content.

The service platform may be connected to a workstation to be accessed by an analyst for utilizing a set of services rendered by at least one of an analysis module and a reconstruction module.

The system may also include an analysis module to analyze the set of communication and transaction data. The system also includes a reconstruction module to reconstruct an original communication associated with a set of intercepted parties.

The service platform may also create an index to enable a fast search of the data base.

In yet another aspect, the method may include collecting, through a collection interface module of a collection server, a set of communication and transaction data from a network being used by a person of interest. The method also includes separating the set of communication and transaction data to generate a metadata and a content of the set of communication and transaction data. The method also includes storing the content in a storage module of the collection server. The method also includes automatically transmitting at least one of the metadata and a text content to a service platform.

The method may further include organizing the set of communication and transaction data at the service platform. The method also includes analyzing the set of communication and transaction data through an analysis module at the service platform. The method also includes reconstructing the set of communication and transaction data through a reconstruction module at the service platform.

The method further includes creating an index at the service platform to enable a fast search of the database. The method also includes enabling an analyst at a workstation associated with the service platform to access the metadata at the service platform irrespective of a connectivity of the network.

The methods and the systems disclosed herein may be implemented in any means for achieving various aspects. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 illustrates the system architecture including the collection server, a close-up of the collection server, the communication bus, and the service platform.

FIG. 2 illustrates the system overview illustrating a network (WAN), the collection server, the communication bus and the workstation.

FIG. 3 illustrates the process of extracting a set of data from a network being used by the person of interest and a correspondent of the person of interest.

FIG. 4 illustrates a detailed view of the collection server.

FIGS. 5A and 5B illustrates a detailed view of the extraction, collection and separation of the set of communication and transaction data.

### DETAILED DESCRIPTION

This disclosure relates generally to the interception, storage, transportation and analysis of a set of data extracted from a network being used by a person of interest. In the following description, for the purposes of explanation, numerous specific details are set forth in order to provide a thorough understanding of the various embodiments. It will be evident, however, to one skilled in the art that the various embodiments may be practiced without these specific details.

System Overview

The application discloses a method and system to intercept, collect, organize and analyze a set of cyber data and data collected through cyber means and physical means. In one or more embodiments, an analyst of the system may be an analyst at a law enforcement agency, or a management consultancy and may want to collect, consolidate, analyze and visualize a set of raw data acquired through legal means. In one or more embodiments, the analyst may be a part of an intelligence agency, a police force, a law enforcement consulting company and/or management company. In one or more embodiments, the analyst may be part of an investigation. The investigation may be a criminal investigation, a civil investigation, an investigation of an employee violating a corporate regulation/conduct, investigation to ascertain compliance with laws and regulations as well as creating reports verifying such compliance, an investigation to save money and/or resources for a company or any other investigation. In one or more embodiments, the server may further comprise a set of collection interface modules that may collect a set of data from a network through a network filtering device. In one or more embodiments, the network filtering device may intercept the data and the collection interface module may collect the set of communication and transaction data. In one or more embodiments, the network filtering device may intercept the network being used by the person of interest to collect a set of information associated with the person of interest. In one or more embodiments, the person of interest may be a suspect in a criminal investigation, a lead in a criminal investigation, any person of interest (POI) in a criminal and/or civil investigation. In one or more embodiments, there may be a set of collection servers spread through a region with an ability to connect to any network and to extract a set of data from the network. In one or more embodiments, the collection server may further include a storage module, a collection interface module and a data processing engine. In one or more embodiments, the network filtering device may be able to connect to any network, and extract a set of necessary data and/or files from a data processing unit associated with the person of interest. The collection interface module and the data processing engine may then collect the set of communication and transaction data. The data processing engine may then process the set of communication and transaction data to extract a metadata and a content of the set of communication and transaction data. For example, the analyst may be an agent and may want to further investigate a potential suspect in a murder case, and may want to investigate a set of emails sent by the suspect to find any possible leads between the person of interest and other people. Alternatively, the agent may want to read a content of the emails between the suspect and a friend of the suspect to understand a relationship between the person of interest and the victim and/or a modus operandi. In this case, the network filtering device may connect to the network through a network filtering device and extract a set of data from the suspect's computer. The collection interface module may then collect the set of communication and transaction data. In one or more embodiments, the data processing engine and the collection interface module may process the set of communication and transaction data to extract a metadata and a content of the communication and transaction data.

The set of communication and transaction data may consist of a metadata (e.g. IP address, email address, cyber-address recipient address, sender address, time of the email, time of the mail, information on a post card, etc.). The metadata may be an information about the data in one or more embodiments. The metadata may encompass a time and place that the data was received. The metadata also encompass a set of information related to the senders and receivers of the information, a time of a communication event, or where an information was collected from. For example, if an email is sent to the POI, the metadata may consist of the sender and recipient addresses of the email, an IP address and a time of the email among others. The data may also consist of a content. The content may be the substantive part of the data collected. The data may consist of the actual text of the email, attachments in the email and what the information actually says. In the previous example, the content may be the actual text of the email which may be a solicitation for a crime. The system may make a distinction between content and metadata. For example, in one embodiment, the analyst 140, upon searching for a particular record, may only be able to view the metadata associated with a particular profile. The analyst may not need to view the content of emails exchanged by the person of interest. Instead, the analyst may only be interested in viewing who the person of interest has been communication with, and the subject line of the email, in one or more embodiments. In another embodiment, after sufficient investigation, the analyst may then be interested in reading the content of the emails exchanged between the person of interest and a particular correspondent of the person of interest, and the analyst may request that the content be transmitted in the communication bus to be viewed by the analyst. The metadata may also be a cyber-name, a cyber-address, contact list, an analyst login information, a chat IP address, a chat alias, a VOIP address, a web forum login, a website login, a social network login, a sender and/or receiver of a chat, a time of a chat conversation, a file name sent in a chat or an email or any other cyber-communication, a number of files transferred in the cyber communication, a type of chat text, a name of an audio and/or video attachment sent in the cyber communication, a number of parties involved in a communication, a buddy list, an avatar description associated with the cyber communication. The metadata may also be associated with voice and/or voice over IP communications. The metadata may also be associated with social networking sites, and may include an analyst name, a time of a social networking communication or publication, a size of a social networking communication, a number of followers and others. The metadata may also include telephone numbers, phone numbers, IMSI information and/or IMEI information.

Similarly, the content may include the substantive portion of a record. In addition to the text of the communication, or a transcript of a recorded conversation, it may also include a text of an email attachment, a transferred file, a content of an uploaded or downloaded document/video or any other file, a pooled information between many users, a substance of social network communication, a tweet, a message exchanged between two parties, a substance of a text message, and any other communication.

In one or more embodiments, the collection interface module and the data processing engine may process the set of communication and transaction data to extract the metadata and the content of the set of the communication and transaction data. In the current example, in investigating a set of data from the person of interest (in this case, the suspect of the criminal investigation), the metadata may consist of a set of contacts that the person of interest has been emailing in the past 7 days, whereas the content may be the actual text of the emails exchanged between the person of interest and the set of contacts. In one or more embodiments, the collection server may store the content in the storage module of the collection server. In one or more embodiments, the metadata and any text content may be transmitted to the service platform through the communication bus.

In one or more embodiments, the communication bus may be a mode of electronic transportation linking the set of collection servers sprawled across the world. In one or more embodiments, the metadata and any text content may be automatically transmitted to the database in the service platform. In one or more embodiments, the storage module may be a database. The analyst at the service platform may then be able to immediately access the metadata and text content to analyze and visualize the set of communication and transaction data. If the analyst does decide to view the content, the analyst may request the information stored in the storage module and the content may then be transmitted to the analyst through the communication bus.

In one or more embodiments, the service platform may be further connected to a workstation that may be accessed by an analyst. In one or more embodiments, the analyst working at the workstation may easily access the metadata stored in the service platform, and may not have to unnecessarily wait for the content that is being stored in the storage module of the collection server. In one or more embodiments, the analyst may not at all be interested in knowing the content of a set of communications between the person of interest and a correspondent of the person of interest, thereby saving a set of costs and time associated with transporting a large amount of data across servers in the communication bus.

The server may be any brand of server and any type of server computer, blade server or any other processing device capable to performing the data management and communication functions with any quantity of cores, e.g. a six (6) core X86 Intel Quad Xeon MP, which may be programmed for any type of operating system (“OS”), e.g., Solaris UNIX, LINUX, or other server computing OS. In one or more embodiments, the system may be run on an Intel86 based processor using Linux RHEL with 64 bit OS. The system may be run on a direct or NAS storage device or appliance. The system is not limited to Intel x86, Linux RHEL, Direct/NAS storages and can be implemented on any computer hardware, OS and storage devices. Any commercially available or proprietary design DPU may be used for this function given the adaptation and implementation of drivers specific to the actual device.

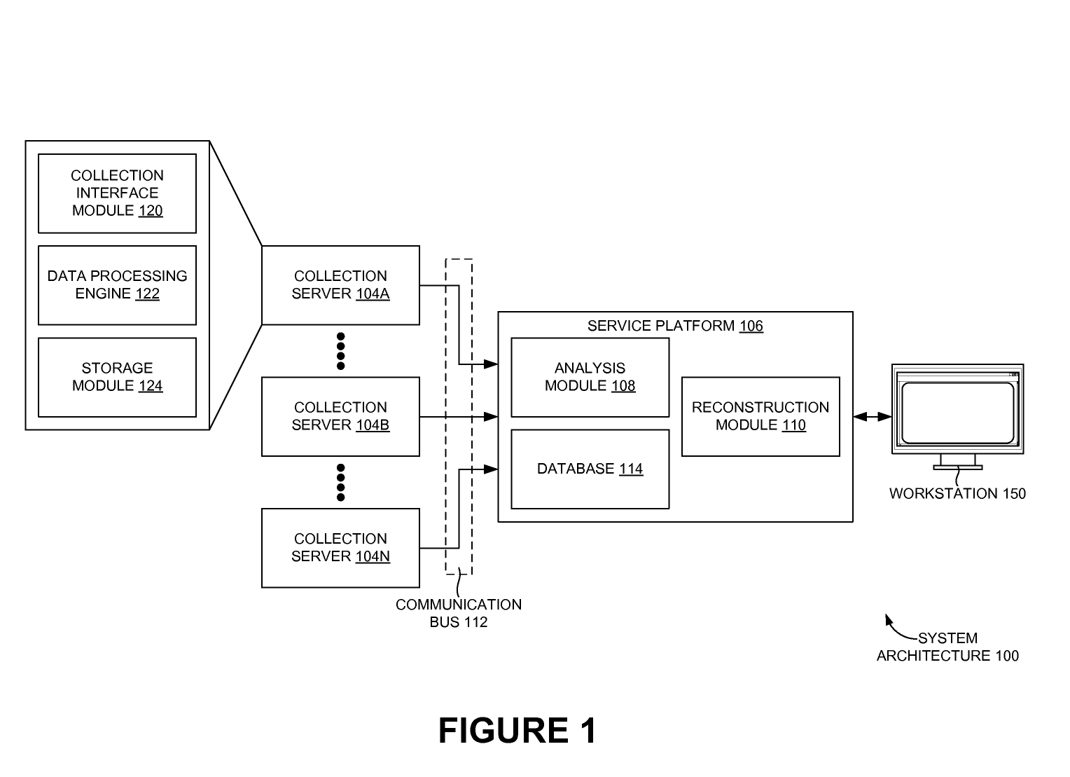

FIG. 1 is a figure of the system architecture and illustrates, in detail, a collection interface module 120, a data processing engine 122, a storage module 124, a collection server 104, a service platform 106, an analysis module 108, a database 114, a reconstruction module 110 and a workstation 150.

In one or more embodiments, the collection server may be able to collect a set of communication and transaction data from a data processing unit associated with a person of interest. The person of interest, as mentioned previously, may be any person of interest, in one of more embodiments. In one or more embodiments, there may be many collection servers 104 A, 104 B, 104 N situated around the world. The collection server 104 may further comprise a collection interface module, a data processing engine 122 and a storage module 124. The collection interface module 120 may collect a set of communication and transaction data from the network, and may be able to connect to any network, in one or more embodiments. In one or more embodiments, the collection interface module may be coupled to a network filtering device that may connect to the network and collect relevant set of data exchanged by the data processing unit associated with the person of interest.

In one or more embodiments, the network filtering device may enable the collection server to connect to at least one of a network at a data repository to collect the set of communication and transaction data, irrespective of a format of the set of data. In one or more embodiments, the network filtering device may be able to probe into a network to collect the set of communication and transaction data. In another embodiment, the communication and transaction data may also be collected from a data repository. The data repository may be a database, a data storage module, a data storage device, a CD, a DVD, a hard drive, a hard disk, a floppy disk, a USB data storage device and any other data repository.

In one or more embodiments, the collection servers 104 may be connected to the service platform 106 through the communication bus 112. The communication bus 112 may allow for a transmittal of data from the collection server 104 to the service platform 106. In one or more embodiments, a speed of transport of a set of data communication through the communication bus 112 may be directly proportional to the size of data. For example, a small amount of data may be transmitted at a lower cost and may require a smaller period of time when compared to a larger amount of data.

In one or more embodiments, the collection server 104 may further comprise the data processing engine 122 and the storage module 124. In one or more embodiments, the data processing engine may process the set of communication and transaction data to extract a metadata and a content. In one or more embodiments, the set of communication and transaction data may be processed to extract the metadata and the content from the set of communication and transaction data. In one or more embodiments, the content may be stored in the storage module 124 at a location of the collection server. In one or more embodiments, the metadata and any text content of the set of communication and transaction data may be instantly transmitted via the communication bus 112 to the service platform 106. For example, the analyst may be located in San Jose, Calif. The data processing unit associated with the person of interest may be located in Hawaii. There may be a collection server geographically close to the data processing unit located in Hawaii. The collection interface module 120 in this case may also be located in Hawaii. The collection interface module may be able to collect the set of communication and transaction data from the network being used by the person of interest. The data processing unit may contain a processor and a memory. After extracting the set of data from the person of interest's computer or data processing system, the data processing engine 122 of the collection server 104 may separate the set of data to extract a metadata, a text content and a content.

The metadata may comprise only 0.05% to 5% of the set of data. The text content may comprise 1% to 5% of the data. The remaining set of data may be content. The 96% of the set of communication and transaction data may be stored locally in the collection server 104 located in Egypt. The remaining 4% of the metadata and the text content may be automatically transmitted to the analyst located in San Jose. The analyst working at the workstation 150 may then be able to work with the metadata to find leads on the case. For example, the analyst may not at all be interested in what the person of interest may be saying to his correspondents. Rather, the analyst may be more interested in who the person of interest is communicating with, and a time of correspondence. In one or more embodiments, since metadata is data about data, the analyst may be able to find all the relevant information for the investigation solely based on the metadata, and may not need to examine the content at all. Based on a request of the analyst, the content may then be transmitted to the analyst when the analyst wants to access the content. For example, the analyst may find frequent email transmissions between the person of interest and a particular correspondent, and the analyst may want to access the content of the emails. The analyst may then request that the content be transmitted over to San Jose as well.

In one or more embodiments, the service platform 106 may further comprise a database 114, and a set of other modules to visualize and analyze the set of communication and transaction data. In one or more embodiments, the metadata and the text content may be stored in the database 114. In one or more embodiments, the workstation 150 may be coupled with a user interface allowing the analyst to access, analyze and visualize the set of communication and transaction data.

In one or more embodiments, the collection server 104 may be in a cloud. In one or more embodiments the collection server 104 may be connected to a database of a service provider. The database may also be in a data processing unit associated with the person of interest.

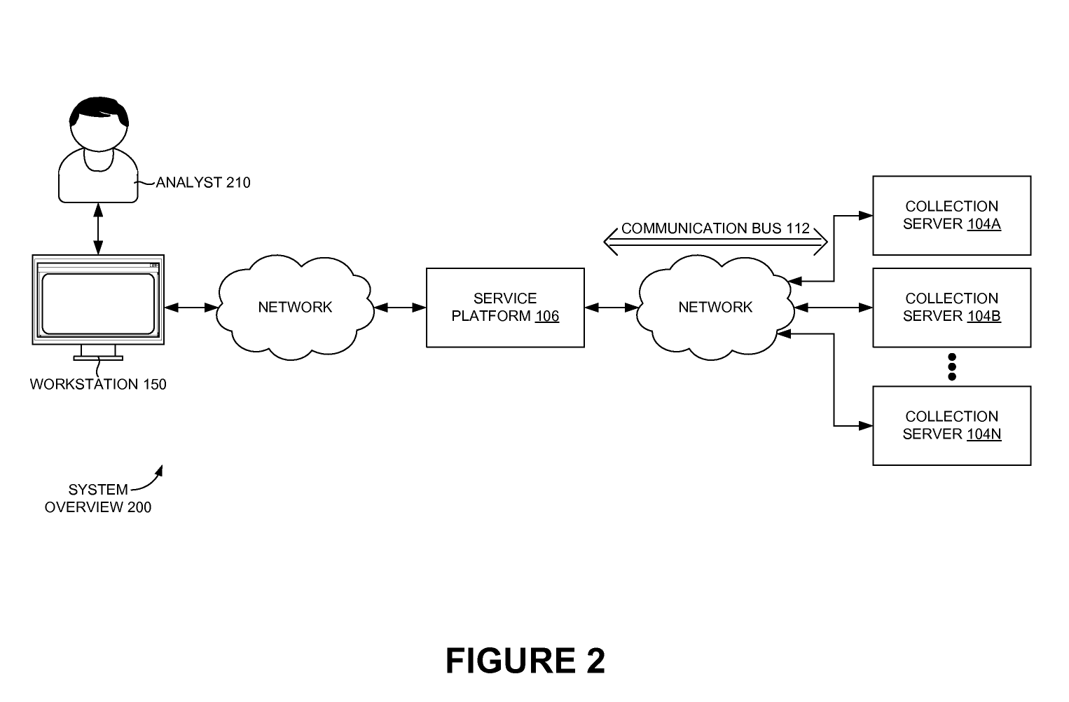

FIG. 2 illustrates the analyst 210, the workstation 150, a wide area network (WAN), the service platform 106, the collection server 140 and the communication bus 112.

In one or more embodiments, workstation 150, the service platform 106, the collection server 104 and the communication bus 112 may all be able to communicate with each other through a connection of the WAN. The network may be also be a local network or any other network that may connect the servers with each other.

In one or more embodiments, the workstation being used by the analyst 210 may be connected to the service platform 106 through a particular network, and the communication bus 112 may span another network to connect the collection servers 140 with the service platform 106.

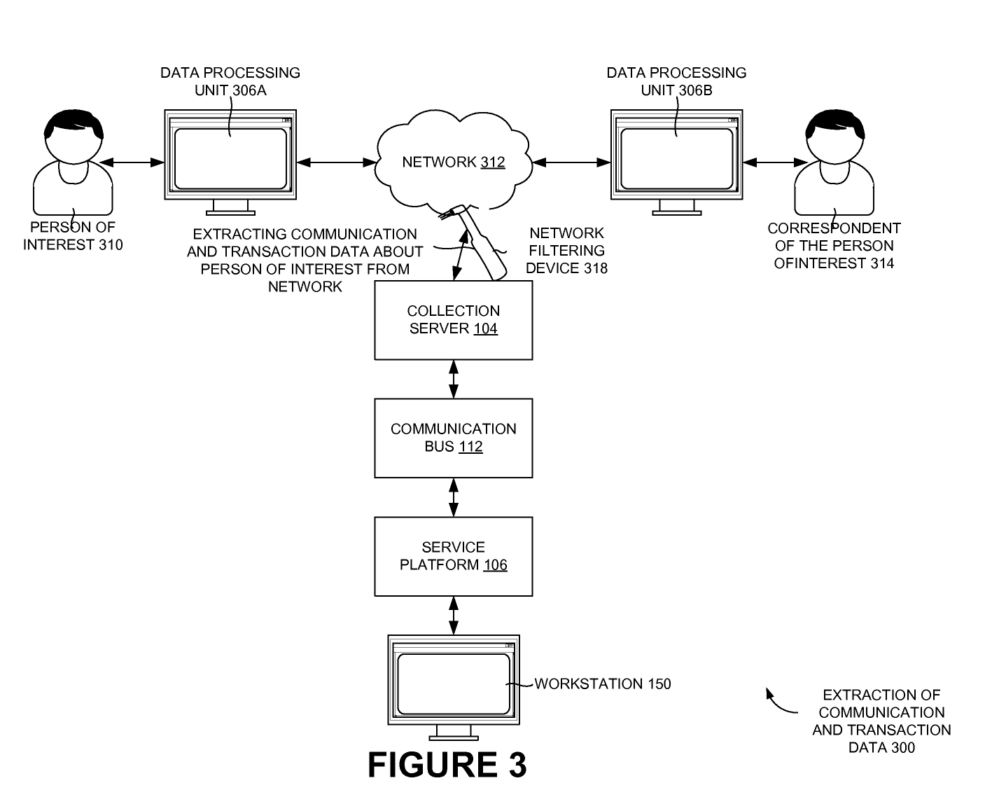

FIG. 3 illustrates the person of interest 310, the data processing unit 306 A, 1 network 312 being used by the person of interest, the data processing unit 306B, a correspondent of the person of interest 314, a network filtering device 318, the collection server 104, the communication bus 112, the service platform 106 and the workstation 150.

In one or more embodiments, the person of interest 310 may be connected to a network 312. The person of interest may be receiving emails and/or other electronic communications through the network 312. The person of interest 310 may have received a set of emails from the correspondent 314. Both the person of interest and the correspondent may be accessing the set of emails through their data processing units 306A and 306B.

In one or more embodiments, the collection interface module of the collection server 104 may use a network filtering device to connect to the network 312. Using the network filtering device 318, the collection server 318 may be able to extract the set of data from the data processing unit 3106A. The set of communication and transaction data may comprise a set of files associated with the network, and any electronic communication between the person of interest and correspondents of the person of interest. In one or more embodiments, the collection server may receive the set of communication and transaction data through the collection interface module. In one or more embodiments, the set of communication and transaction data may include a set of emails, a set of websites visited by the person of interest, a set of chat messages between the person of interest and other correspondents, an SMS, an MMS, a data stored in a cell phone, a data stored in a PDA, a social network interaction, a telephone call, a post on a blog, a post on a social network, and other cyber communications.

In one or more embodiments, the collection server 104 may then process the set of communication and transaction data to extract the metadata and the content of the set of communication and transaction data. The metadata and the text content may then be transmitted automatically through the communication bus to the service platform. The content, on the other hand, may be stored locally at the storage module in the collection server and may only be transmitted as needed. The text content may comprise a textual content of an email subject line, a body of an SMS, a body of an MMS text, a text message, a chat content, a subject of a social network communication.

In one or more embodiments, the service platform 106 may receive the metadata and the text content. The metadata and the text content may be stored in a database in the service platform. In one or more embodiments, the various modules at the service platform may provide capabilities to the analyst to process, analyze and visualize the data to make sense of the communication and transaction data. This set of data may then be accessed by the analyst working at the workstation 150. In one or more embodiments, the service platform may be accessed by multiple users. In one or more embodiments, the analysts may be able to conduct fast searches on the set of data in the database. In one or more embodiments, the search may take a shorter period of time because only the metadata and the text content may be stored in the database. In one or more embodiments, the service platform may include an index of the data stored in the database at the service platform to enable a fast search of the data stored in the database and the storage modules.

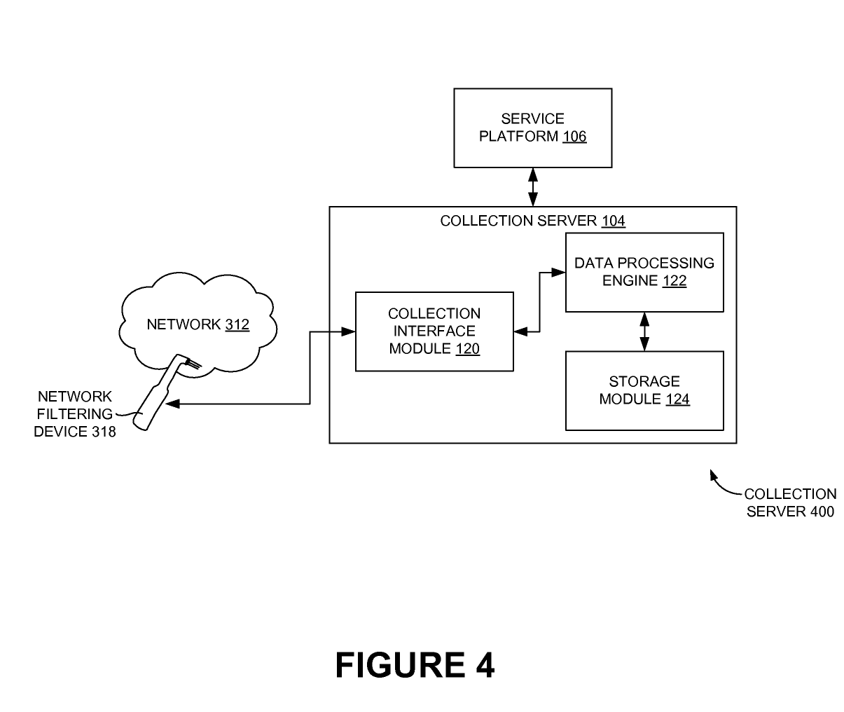

FIG. 4 is a view of the collection server 104 and illustrates the network filtering device 318, the network 312, the storage module 124, the collection interface module 120 and the data processing engine 122.

In one or more embodiments, the collection interface module 120 may connect to the network 312 being used by the person of interest through the network filtering device 318. The network filtering device 318 may be able to connect to any IP network element, TDM elements and may also connect to other databases. In one or more embodiments, the network filtering device 318 may be an AXS5500 network filtering device that may be able to stick onto any network and read a set of data being transmitted across the network. In one or more embodiments, a network element may be a manageable logical entity uniting one or more physical devices. In one or more embodiments, the network element may enable a collection of communication and transaction data from the network being used by the person of interest. In one or more embodiments, the network element may be a mediation function. The mediation function may collect the communication and transaction data from the network element and convert a format of the communication and transaction data to a universal format to be used by the system.

In one or more embodiments, the collection interface module 120 may use the right type of network filtering device based on the network being used by the person of interest. In one or more embodiments, the data processing engine 122 may further comprise analysis and processing modules to process and analyze the set of communication and transaction data. The data processing engine may separate the set of communication and transaction data through a set of tags. For example, the data processing engine may extract the metadata and the content based on a data format, a tag and any other predetermined criteria set by the analyst and/or system.

In one or more embodiments, after processing and separating the set of communication and transaction data, the content may be stored locally at the storage module while the metadata and the text content are transmitted through the communication bus to the service platform 106.

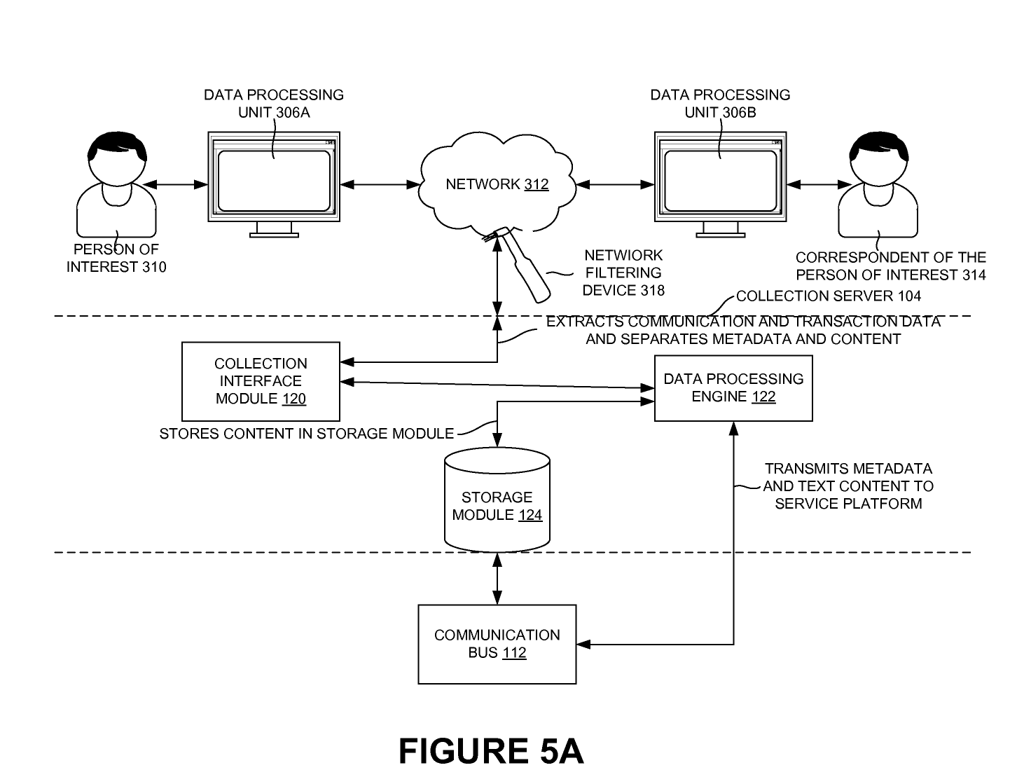

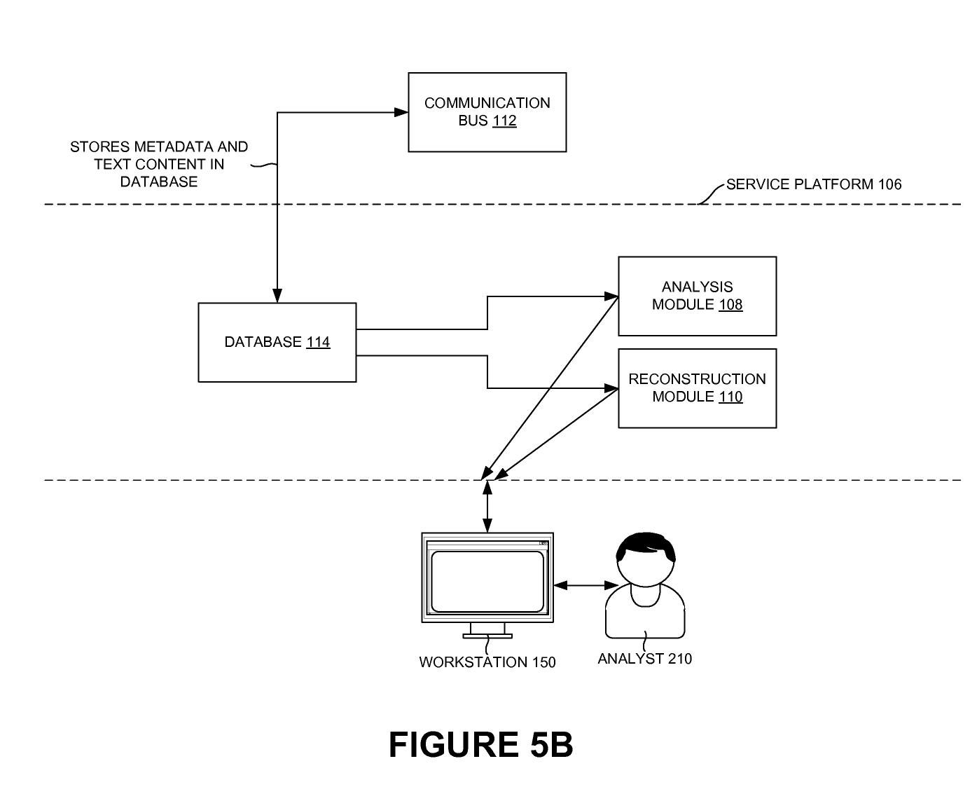

FIGS. 5A and 5B illustrate the interception of data, the collection and storage of data and analysis of the data. In particular, they show the person of interest 310, the correspondent 314, the network 312, the data processing units 306A and 306B, the collection interface module 120, the data processing engine 122, the storage module 124, the communication bus 112, the database 114, the data processing engine 122B, the analysis module 108, the reconstruction module 110, the retargeting module, the workstation 150 and the analyst 210.

In one or more embodiments, the network filtering device 318 intercepts the network 312 being used by the person of interest 310, and extracts a set of data associated with the person of interest. The set of data may be a set of emails with a set of correspondents, a set of emails visited, a set of chat records, a set of IP addresses etc. The collection server may then receive the set of data from the network filtering device 318 and the collection server 104 may receive the set of communication and transaction data.

In one or more embodiments, the collection interface module may collect the set of communication and transaction data intercepted by the network filtering device. In one or more embodiments, the data processing unit, in conjunction with the collection interface module may receive the set of communication and transaction data and process the set of data to extract the metadata and the content of the set of communication and transaction data. The collection interface module and the data processing engine may automatically transmit the metadata and the text content to the service platform 106 through the communication bus 112 in one or more embodiments. In one or more embodiments, the content may be stored in the storage module 124.

In FIG. 5B, the service platform 106 may receive the metadata and the text content and may store the metadata and the text content in the database 114. In one or more embodiments, the service platform may be coupled with a data processing engine 122B that may in turn be coupled to a processor and a memory. The data processing engine 122 B may be further coupled to a set of modules. In one or more embodiments, the service platform 106 may comprise of an analysis module 108, a reconstruction module 110, a visualization module and a retargeting module. The analysis module may analyze the set of communication and transaction data based on a set of predetermined association factors in one or more embodiments. In one or more embodiments, the analysis module may find links between unrelated sets of data. In one or more embodiments, the reconstruction module may reconstruct a line of communication between a person of interest a set of correspondents through various communication methods. In one or more embodiments, the service platform may be coupled to an analysis module that may be owned by a third party. For example, the analyst may be located in San Jose, in the previous example, but may want to work with a third party that may analyze data to form links and/or associations using a different algorithm. In one or more embodiments, the algorithm may be developed by the analyst. In another embodiment, the algorithm may be developed by the third party.

In one or more embodiments, the service platform 106 may be coupled to a set of workstations. The analyst 210 may access the set of communication and transaction data and the analysis of the set of communication and transaction data through an analyst interface associated with the workstation.

Although the present embodiments have been described with reference to specific example embodiments, it will be evident that various modifications and changes may be made to these embodiments without departing from the broader spirit and scope of the various embodiments.

What is claimed is:

1. A method comprising:
distributing a set of collection servers throughout a distributed network to collect a set of communication and transaction data;
extracting the set of communication and transaction data, through a collection interface module and a data processing unit at the collection server;
processing the set of communication and transaction data, through the data processing engine, to extract metadata and a content;
storing the content in a storage module in the collection server; and
transmitting at least one of the metadata and a text content in a communication bus to a service platform.

2. The method of claim 1 further comprising:
transmitting the content in the communication bus at a request of an analyst for visualization and analysis; and
reducing a traffic on the network by transmitting the content only at the request of the analyst.

3. The method of claim 1 further comprising:
collecting the set of communication and transaction data through a network element,
wherein the network element is at least one of a network filtering device, a mediation function and a data repository.

4. The method of claim 1 further comprising:
organizing the set of metadata and text content of the set of communication and transaction data at the service platform;
analyzing the set of data through an analysis module at the service platform; and
reconstructing the set of data though a reconstruction module at the service platform.

5. The method of claim 1 wherein the metadata is at least one of an information about an IP packet, an information about a type of data collected, an IP address information, a cyber-address, a password, an event information, a geographical information about an event, a source and destination IP address of a cyber-activity, a version, a length, a set of cyber options, a padding information , error correction information, identification of a sender of an email, identification of a receiver of a cyber-communication, a flag associated with a cyber-communication, a protocol information, a subject line of a cyber-communication, an attachment information, a routing information and a proxy server information, a telephony record, a social networking data and address of a website, a mac address, a telephony address, a chat address, a chat title, an IMEI, and IMSI, a social networking address, a subject of a cyber-communication, a metadata for flight data, a metadata for financial data.

6. The method of claim 1 wherein the content is at least one of a content of an email, an attachment, a content of a website, a content of an electronic chat, a content of a web address, a content of an article, a set of files transmitted across the network, a set of images, a set of audio files, a set of video files, a chat transcript, an email transcript, a telephone transcript, a substantive content of an electronic transmission, a substantive content of an electronic conversation, a set of data associated with a cyber-address, a set of data associated with a physical address, a set of data associated with the geographical location, a set of data associated with a web host, a set of data associated with a warrant, a content for flight data and a content for financial data.

7. The method of claim 1 further comprising:
storing the metadata in a database in the service platform;
creating an index at the service platform to enable a fast search of the database; and
enabling an analyst at a workstation associated with the service platform to analyze the metadata at the service platform irrespective of a connectivity of the network.

8. The method of claim 7 further comprising:
storing the text content in the database in the service platform;
creating an index and the service platform to enable a fast search of the database; and
enabling the analyst at the workstation to analyze the text content at the service platform irrespective of the connectivity of the network.

9. The method of claim 1 further comprising:
enabling the collection server to connect to at least one of a network and a data repository to collect the set of data, irrespective of a format of the set of data.

10. The method of claim 1 further comprising:
developing an interface with a third party to provide an access to the database in the service platform;
coupling the service platform with an analysis module associated with the third party to integrate a set of analytical services provided by the third party.

11. A system comprising a processor communicatively coupled with a volatile memory and a non-volatile storage further comprising:
a collection server:
to collect a set of communication and transaction data from a network
to process the set of communication and transaction data,
to extract a metadata and a content of the set of communication and transaction data,
to store the content,
a service platform:
to receive and store the metadata and the text content
to present the set of communication and transaction data to an analyst,
a communication bus:
to automatically transmit the metadata and a text content to the service platform from the collection server immediately at a time of collection of the set of communication and transaction data, and
to transmit the content to the service platform at a request of the analyst.

12. The system of claim 11 further comprising:
a database in the service platform to store the metadata and the text content.

13. The system of claim 12 further comprising:
a storage module in the collection server to store the content;
a collection interface module in the collection server to collect the set of communication and transaction data; and
a data processing engine in the collection server to process the set of data and to extract the metadata and the content.

14. The system of claim 11 wherein the service platform is connected to a workstation to be accessed by an analyst for utilizing a set of services rendered by at least one of an analysis module and a reconstruction module.

15. The system of claim 11 wherein the service platform further comprises:
an analysis module to analyze the set of communication and transaction data, and
a reconstruction module to reconstruct an original communication associated with a set of intercepted parties.

16. The system of claim 11 wherein the service platform creates an index to enable a fast search of the database.

17. A method comprising:
collecting, through a collection interface module of a collection server, a set of communication and transaction data from a network being used by a person of interest;
separating the set of communication and transaction data to extract a metadata and a content of the set of communication and transaction data;
storing the content in a storage module of the collection server; and
automatically transmitting at least one of the metadata and a text content to a service platform.

18. The method of claim 17 further comprising:
organizing the set of communication and transaction data at the service platform;
analyzing the set of communication and transaction data through an analysis module at the service platform; and
reconstructing the set of communication and transaction data though a reconstruction module at the service platform.

19. The method of claim 17 further comprising:
storing at least one of the metadata and a text content at a database at the service platform.

20. The method of claim 17 further comprising:
creating an index at the service platform to enable a fast search of the database; and
enabling an analyst at a workstation associated with the service platform to access the metadata and the text content at the service platform irrespective of a connectivity of the network.
